(19) United States
(12) Patent Application Publication
(10) Pub. No.: US 2006/0284449 A1
(43) Pub. Date: Dec. 21, 2006

(54) Sub-frame of vehicle

(75) Inventor: Tetsuya Miyahara, Saitama (JP)

Correspondence Address: ARENT FOX PLLC, 1050 CONNECTICUT AVENUE, N.W., SUITE 400, WASHINGTON, DC, 20036, US

(73) Assignee: HONDA MOTOR CO., LTD.

(21) Appl. No.: 11/453,879

(22) Filed: Jun. 16, 2006

(30) Foreign Application Priority Data
Jun. 17, 2005 (JP) P.2005-178408

(51) Int. Cl. B60K 37/00

(52) U.S. Cl. 296/204; 296/203.01; 296/205

(57) ABSTRACT

A sub-frame 11 of a vehicle, which is made by means of die casting into a substantially rectangular shape and attached to a front lower portion 14 of a vehicle body 13, includes: a C-shaped front sub-frame 15; and a C-shaped rear sub-frame 16, wherein a right and a left front beam members 65, 67, which are formed at a right and a left end portion of a front beam member 47 constituting the front sub-frame 15, and a right and a left beam rear members 96, 97, which are formed at a right and a left end portion of a rear beam member 53 constituting the rear sub-frame 16, are joined to each other, and flat portions 113, 114 are formed in the right and the left front beam members 65, 67 so that the flat portions can be start points of plastic deformation of the sub-frame 11 when a load, which is heavier than a normal load, is given to the sub-frame 11 in the longitudinal direction.

### BACKGROUND OF THE INVENTION

The present invention relates to a substantially rectangular sub-frame of a vehicle attached to a front lower portion of a vehicle body.

Concerning the substantially rectangular sub-frame made by means of die casting, a hollow frame for vehicle use and a vehicle are well known. For example, refer to Patent Document 1.

[Patent Document 1]

JP-A-2004-210013 (FIG. 3 on page 11)

Referring to the following drawing, Patent Document 1 will be explained below.

FIG. 13 is a view for explaining a basic structure of a sub-frame of the conventional art (Patent Document 1). A hollow frame (sub-frame) 201 for vehicle use of the conventional art is constituted in such a manner that a lid body 203 made of aluminum alloy is joined to a frame body 202 made of an aluminum alloy casting so as to form a hollow portion. This hollow frame (sub-frame) 201 for vehicle use of the conventional art is advantageous in that the weight is small and it can be easily manufactured at a low manufacturing cost.

However, in the case of the hollow frame (sub-frame) 201 for vehicle use described in Patent Document 1, when a size of the frame body 202 made of an aluminum alloy casting is expanded, a large frame body can not be made by means of casting being restricted by an existing casting apparatus.

In order to manufacture a large frame body 202 with the existing casting apparatus, for example, it is possible to adopt a method in which the frame body 202 made by casting is divided into two blocks. In the case where the frame body 202 made by casting is divided into two blocks, of course, the divided blocks are integrally joined to each other so as to obtain a substantially rectangular frame body. In this case, it takes time and labor to join the divided blocks. Therefore, even in the case of dividing the frame body into two blocks, it is desired to provide a structure in which it does not take time and labor to set a shape and to make an edge preparation.

### SUMAMRY OF THE INVENTION

It is an object of the present invention to provide a sub-frame of a vehicle capable of enhancing a degree of freedom of a shape of a joining portion even when a substantially rectangular sub-frame made by die casting is constituted being divided into two blocks.

According to the aspect 1 of the invention, there is provided with a sub-frame of a vehicle, which is made by means of die casting into a substantially rectangular shape and attached to a front lower portion of a vehicle body, including: a C-shaped front sub-frame including a front beam member, a right front beam member extending from one end portion of the front beam member backward the vehicle body and a left front beam member extending from other end portion of the front beam member backward the vehicle body; and a C-shaped rear sub-frame including a rear beam member, a right rear beam member extending from one end portion of the rear beam member frontward the vehicle body and a left rear beam member extending from other end portion of the rear beam member frontward the vehicle body, wherein the right front beam member and the right rear beam member are jointed to each other, the left front beam member and the left rear beam member are jointed to each other, and vulnerable portions are formed in the right and the left beam member and are placed apart from jointed portions.

According to the aspect 2 of the invention, there is provided with the sub-frame of a vehicle according to aspect 1, wherein cross-sections of the right and the left front beam members, and the right and the left rear members are respectively formed into a hollow cross-section, one side of which is open, and a part of open portions of the cross-sections that include the vulnerable portions are covered by expanded material plate.

According to the aspect 3 of the invention, there is provided with the sub-frame of a vehicle according to aspect 1, wherein the vulnerable portions form flat portions which are thinner than other portions.

According to the aspect 4 of the invention, there is provided with the sub-frame of a vehicle according to aspect 1, wherein the joint portions are slant with respect to the direction along which the right and the left beams extend.

According to the aspect 5 of the invention, there is provided with the sub-frame of a vehicle according to aspect 2, wherein the expanded material plates are jointed by friction stir welding.

According to the aspect 6 of the invention, there is provided with a sub-frame forming method for forming a sub-frame of a vehicle, which is made by means of die casting into a substantially rectangular shape and attached to a front lower portion of a vehicle body, the method including the steps: forming a C-shaped front sub-frame including a front beam member, a right front beam member extending from one end portion of the front beam member backward the vehicle body and a left front beam member extending from other end portion of the front beam member backward the vehicle body; and forming a C-shaped rear sub-frame including a rear beam member, a right rear beam member extending from one end portion of the rear beam member frontward the vehicle body and a left rear beam member extending from other end portion of the rear beam member frontward the vehicle body, joining the right front beam member and the right rear beam member, and joining the left front beam member and the left rear beam member, wherein vulnerable portions are formed in the right and the left beam member and are placed apart from jointed portions.

According to the aspect 7 of the invention, there is provided with the sub-frame forming method according to aspect 6, wherein cross-sections of the right and the left front beam members, and the right and the left rear members are respectively formed into a hollow cross-section, one side of which is open, and a part of open portions of the cross-sections that include the vulnerable portions are covered by expanded material plate.

According to the aspect 8 of the invention, there is provided with the sub-frame forming method according to aspect 6, wherein the vulnerable portions form flat portions which are thinner than other portions.

According to the aspect 9 of the invention, there is provided with the sub-frame forming method according to aspect 6, wherein the joint portions are slant with respect to the direction along which the right and the left beams extend.

According to the aspect 10 of the invention, there is provided with the sub-frame forming method according to aspect 7, wherein the expanded material plates are jointed by friction stir welding.

According to the invention described in aspects 1 and 6, the sub-frame made by die casting is constituted in such a manner that the right and left rear beam members are joined to the right and left front beam members of the front sub-frame, and the flat portions are formed in the right and the left front beam members or the right and the left rear beam members so that the flat portions can be start points of plastic deformation when a load, which is heavier than a normal load, is given to the flat portions in the longitudinal direction. Therefore, when the mechanical strength of the right and the left joining portions is the same as the mechanical strength of the shape on a mother material side of the right and the left beam member or the mechanical strength of the right and the left joining portions is higher than that, there is no possibility that the joining portion is plastically deformed. Accordingly, a degree of freedom of the shape of the joining portion can be advantageously enhanced.

When the degree of freedom of the shape of the joining portion is enhanced, a degree of freedom of welding is enhanced. Accordingly, it is possible to reduce the working time of joining.

According to the invention described in aspects 2 and 7, cross-sections of the right and the left front beam members and the right and the left rear beam members are respectively formed into a hollow shape, one side of which is open, and an expanded material plate is joined to the hollow cross-section so as to close the opening at least in the flat portion. Accordingly, a load can be positively transmitted to a rear attaching portion provided at the rear being controlled not by breaking but by bending the expanded material plates (the right and the left bottom plate). As a result, it is possible for the rear attaching portion to be detached from a vehicle body and to be slid backward, that is, it is possible for the rear attaching portion to ensure a crashable stroke.

### BRIEF DESCRIPTION OF THE DRAWINGS

FIG. 1 is a schematic illustration for explaining an outline of a sub-frame of a vehicle of the present invention.

FIG. 2 is a schematic illustration for explaining a state in which an engine is mounted on the sub-frame of a vehicle of the present invention.

FIG. 3 is a plan view of the sub-frame of a vehicle of the present invention.

FIG. 4 is an exploded view of the sub-frame of a vehicle of the present invention.

FIG. 5 is a perspective view of the sub-frame of a vehicle of the present invention.

FIG. 6 is a sectional view taken on line 6-6 in FIG. 3.

FIG. 7 is a sectional view taken on line 7-7 in FIG. 3.

FIG. 8 is a sectional view taken on line 8-8 in FIG. 3.

FIG. 9 is a lower view of a front box member provided in the sub-frame of a vehicle of the present invention.

FIG. 10 is a sectional view taken on line 10-10 in FIG. 9.

FIG. 11 is a first view showing an action of the sub-frame of the present invention.

FIG. 12 is a second view showing an action of the sub-frame of the present invention.

FIG. 13 is a view for explaining a basic structure of the sub-frame of the conventional art (Patent Document 1).

### DETAILED DESCRIPTION OF THE PREFERRED EMBODIMENTS

Referring to the accompanying drawings, the best mode for carrying out the invention will be explained below.

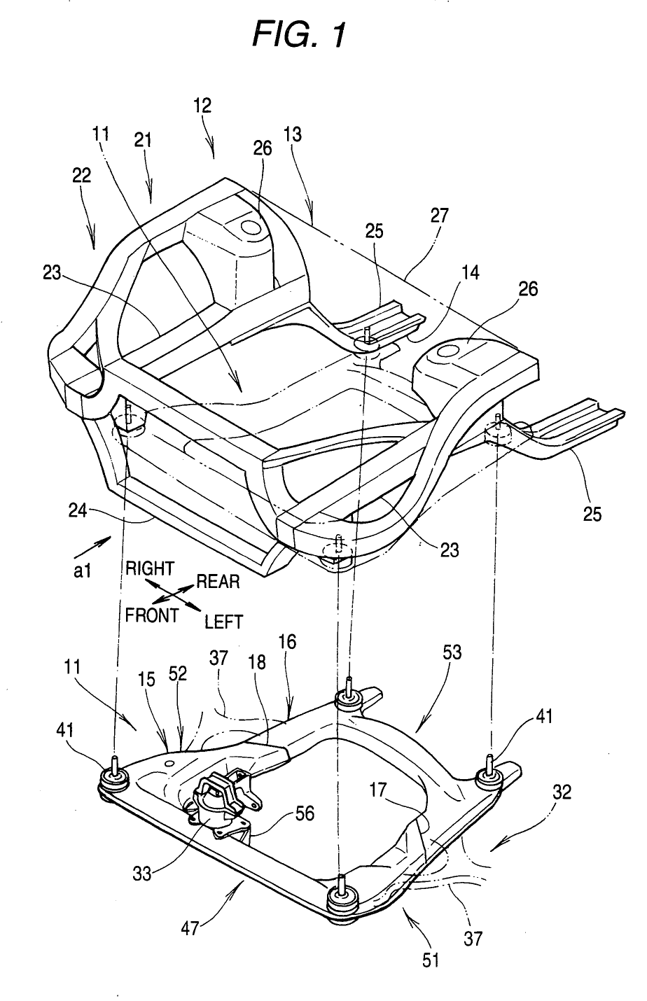

FIG. 1 is a schematic illustration for explaining an outline of a sub-frame of a vehicle of the present invention.

The sub-frame 11 is attached, for example, to a lower portion 14 of a vehicle body 13 of a vehicle 12. The sub-frame 11 includes: a front sub-frame 15; and a rear sub-frame 16, that is, the sub-frame 11 is constituted being divided into two blocks. The thus divided blocks are joined to each other by the right and left joining portions 18, 17. This structure of the sub-frame 11 will be specifically described later.

The vehicle body 13 is provided with a front body 22 which is a front portion 21.

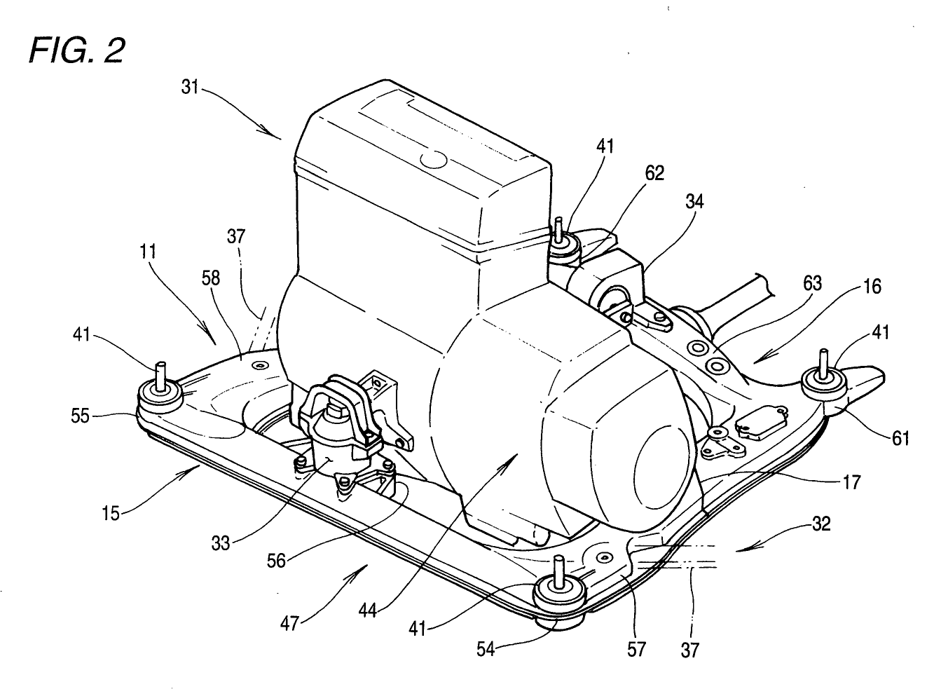

In this case, the front body 22 is used for an FF vehicle. The front body 22 includes: a right and a left front side member 23, 23; a front cross member 24 joined to forward end portions of the front side members 23, 23; floor members 25, 25 joined to rear end portions of the front side members 23, 23; damper housings 26, 26 attached to the front side members 23, 23; a bulkhead 27 for partitioning an engine room; and a sub frame 11 connected to lower portions of the front side members 23, 23 and the floor members 25, 25, wherein the front body 22 supports an engine 31 (shown in FIG. 2) and a front suspension 32. Reference numeral 33 is a front mount device on which the engine 31 (shown in FIG. 2) is mounted, reference numeral 34 (shown in FIG. 2) is a rear mount device on which a rear portion of the engine 31 is mounted and reference numeral 37 is a lower link of the front suspension 32.

FIG. 2 is a schematic illustration for explaining a state in which the engine is mounted on a sub-frame of a vehicle of the present invention. FIG. 2 will be explained together with FIG. 1.

Four corners of the sub-frame 11 are attached to the lower portion 14 of the vehicle body 13 by mount members 41 . . . (Marks . . . represent plurality, which could be also said in the following descriptions.). On the right and the left, the sub-frame 11 supports the front suspension 32. In the front and at the rear, the sub-frame 11 supports the engine 31 via the front and the rear mount device 33, 34. The mount device 33 receives a load given from the engine 31 and absorbs vibration generated by the engine 31 at the same time so that the thus generated vibration can be prevented from being transmitted to the sub-frame 11.

The engine 31 is, for example, a 4-cylinder straight transverse engine. Reference numeral 44 represents a transmission.

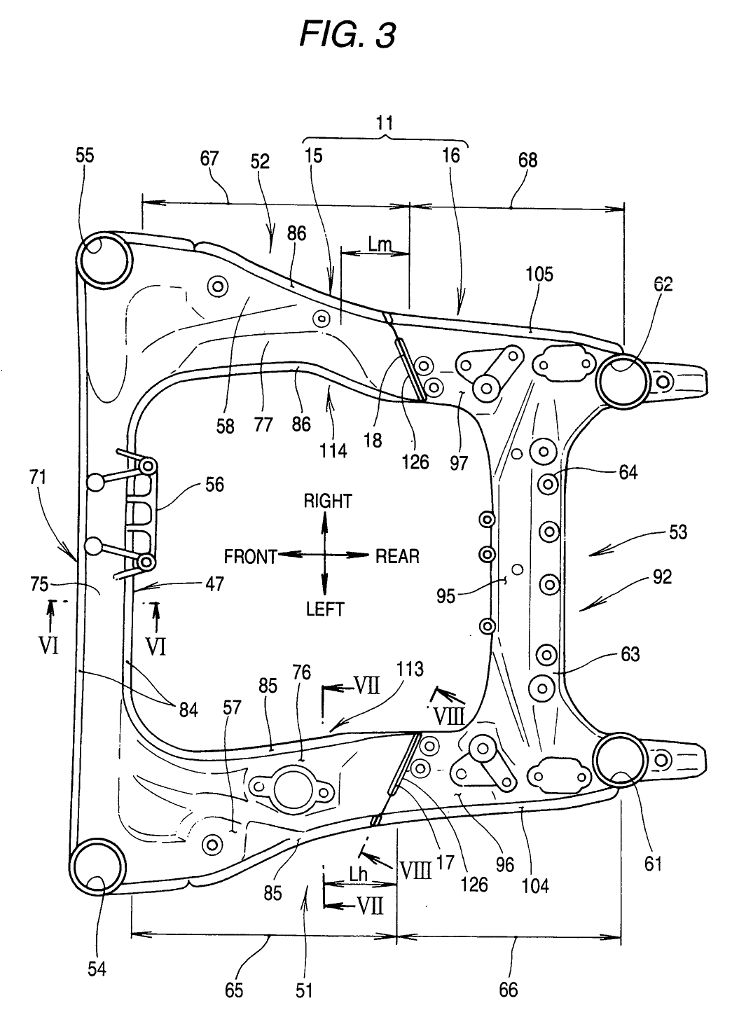

FIG. 3 is a plan view of the sub-frame of a vehicle of the present invention.

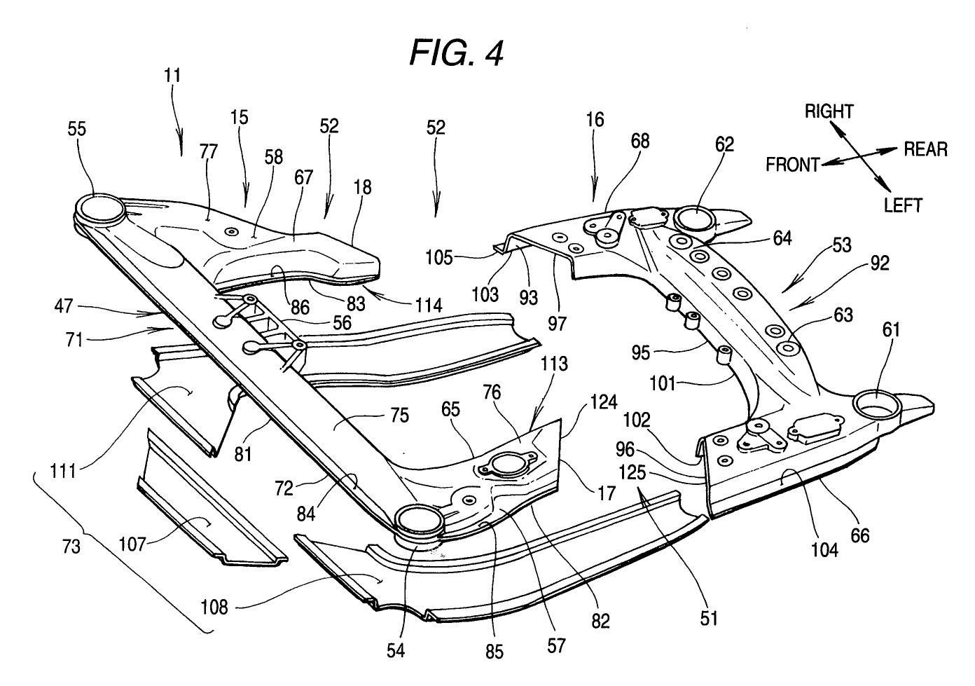

FIG. 4 is an exploded view of the sub-frame of a vehicle of the present invention.

Specifically, the sub-frame 11 is constituted as follows. When the right and left joining portions 18, 17 are welded to each other, the front sub-frame 15 and the rear sub-frame 16 are connected to each other and formed into a substantially rectangular which includes a front beam member 47, a right and a left beam member 51, 52 and a rear beam member 53. Front attaching portions 54, 55 are formed at both end portions of the front beam member 47. A support portion 56 is formed at the center of the front beam member 47. Connecting portions 57, 58 respectively connected the front suspension 32 are formed in the right and the left beam member 51, 52. At the rear end portions of the right and the left beam member 51, 52, rear attaching portions 61, 62 are formed. Steering attaching portions 63, 64 used for attaching a steering device (not shown in the drawing) are formed in the rear beam member 53.

The support portion 56 supports the engine 31 (shown in FIG. 2) via the front mount device 33 (shown in FIG. 2). At the same time, the support portion 56 transmits a load, which is given from the engine 31, to the front beam member 47 (front box body 75).

Next, the front sub-frame 15 and the rear sub-frame 16, which are formed being divided from each other, will be mainly explained below.

When a view is taken from the above, the front sub-frame 15 is formed into a C-shape. A left front beam member 65 is formed at the left end of the front beam member 47, and a right front beam member 67 is formed at the right end of the front beam member 47.

The front sub-frame 15 is constituted as follows. A front box member 71, which is a box-shaped box member made by die casting, is made by means of casting, and a bottom plate 73, which is a lid member made of metal, is joined to an opening 72 of the front box member 71.

The front box member (box member) 71 is constituted as follows. A front box body 75 is formed into a shape, the transverse cross-section of which is a U-shape. A left front box body 76 is integrally formed into a U-shape at the left end of the front box body 75. At an end portion of the front box member 71, a front attaching portion 54 is formed. A right front box body 77 is integrally formed into a U-shape at the right end of the front box body 75. At an end portion of the front box member 71, a front attaching portion 55 is formed. Openings 81 to 83 constituting the opening 72 are formed in the front box body 75 and the right and the left box body 76, 77. In the front opening 81, flange portions 84, 84 are formed. In the left opening 82, left flange portions 85, 85 are formed. In the right opening 83, right flange portions 86, 86 are formed.

When a view is taken from the above, the rear sub-frame 16 is formed into a C-shape. At the left end of the rear beam member 53, a left rear beam member 66 is formed. At the right end of the rear beam member 53, a right rear beam member 68 is formed.

The rear sub-frame 16 is constituted as follows. A rear box member 92, which is a box-shaped box member made by die casting, is made by means of casting, and a bottom plate 73, which is a lid member made of metal, is joined to a portion of an opening 93 of the rear box member 92.

The rear box member 92 is constituted as follows. A rear box body 95 is formed into a shape, the transverse cross-section of which is a U-shape. A left rear box body 96 is integrally formed into a U-shape at the left end of the rear box body 95. A right rear box body 97 is integrally formed into a U-shape at the right end of the rear box body 95. Openings 101 to 103 constituting the opening 93 are respectively formed. In the left opening 102, a left flange portion 104 is formed. In the right opening 103, a right flange portion 105 is formed.

The lid member (bottom plate) 73 is an expanded material plate. The lid member 73 includes: a front bottom plate 107 joined to the opening 81 of the front box body 75; a left bottom plate 108 mainly joined to the opening 82 of the left front box body 76 and the opening 102 of the left rear box body 96; and a right bottom plate 111 mainly joined to the opening 83 of the right front box body 77 and the opening 103 of the right rear box body 97.

In this connection, the lid member (bottom plate) 73 is divided into three pieces. However, the number of divided pieces can be arbitrarily determined, and the positions at which the lid member is divided can be also arbitrarily determined.

In the left front beam member 65, the flat portion 113 (shown in FIG. 7) is formed being separate from the left joining portion 17 by distance Lₕ.

In the right front beam member 67, the flat portion 114 is formed being separate from the right joining portion 18 by distance Lₘ.

In this connection, the flat portions 113, 114 are respectively formed in the right and the left front beam members 67, 65. However, without forming the flat portions 113, 114 in the front right and left members 82, 81, the flat portions can be formed in the right and the left rear beam members 68, 66 like the flat portions 113, 114.

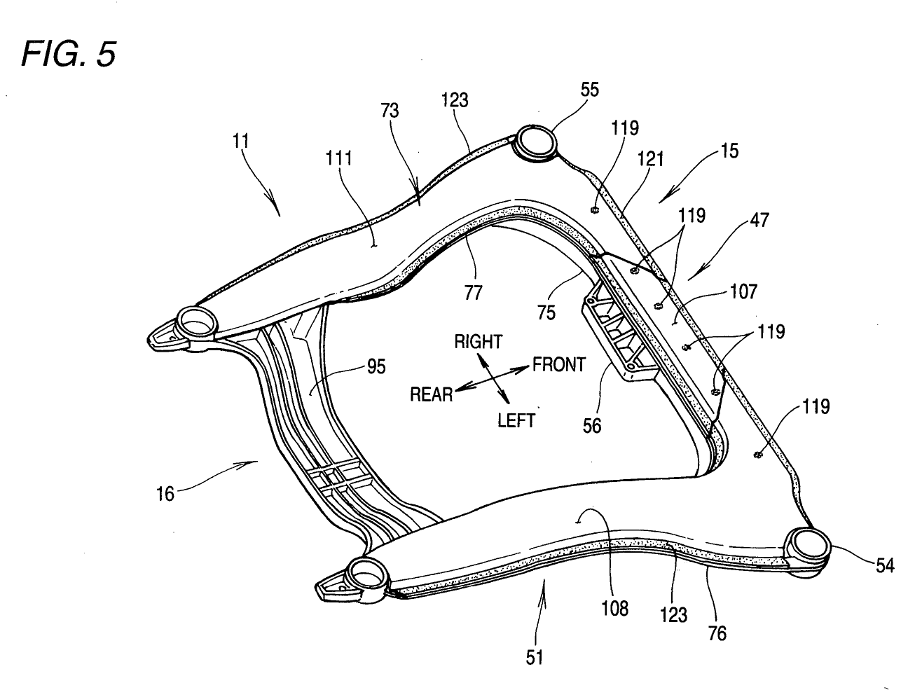

FIG. 5 is a perspective view of the sub-frame of a vehicle of the present invention. In this view, the sub-frame 11 is shown while a bottom side of the sub-frame 11 is being set upward. Explanations will be made into FIG. 5 together with FIGS. 3 and 4.

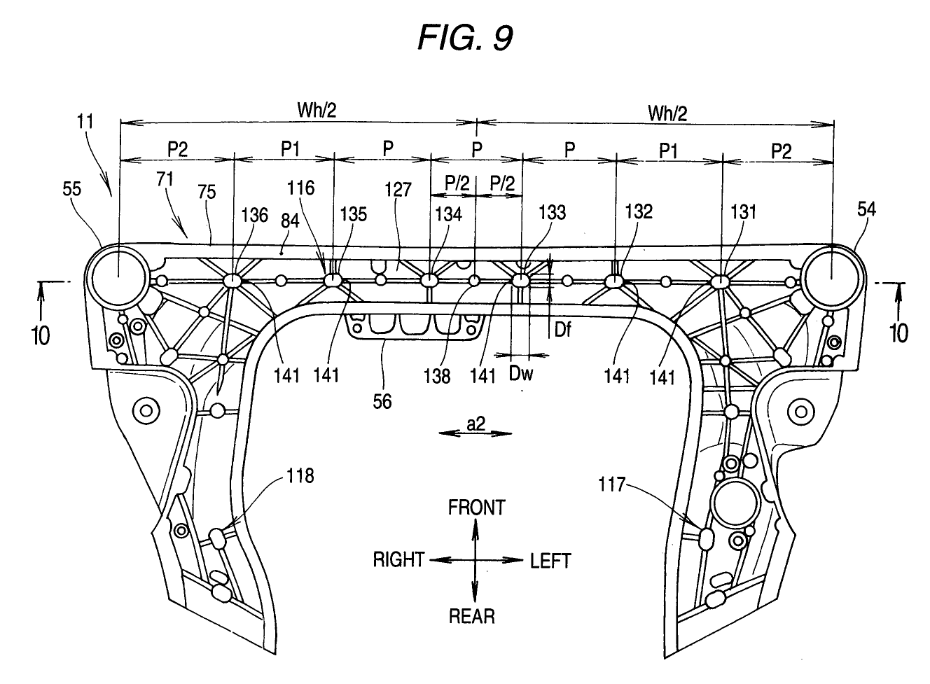

More specifically, the front sub-frame 15 is constituted as follows. A front bottom plate 107 of the lid member (bottom plate) 73 is welded to the flange portion 84 of the front box body 75. In this case, the welded portion is shown by a dotted pattern. At the same time, the front bottom plate 107 is welded to a protruding boss portion 116 (shown in FIG. 9) provided in the front box body 75. In this case, the welded portion is shown by a dotted pattern.

A left bottom plate 108 is welded to the other left flange portions 84, 84 of the front boxy body 75 and the protruding boss portion 116 (shown in FIG. 9). At the same time, a left bottom plate 108 is welded to the left flange portions 85, 85 of the left front box body 76. In this case, the welded portion is shown by a dotted pattern. The left bottom plate 108 is welded to the protruding boss portion 117 (shown in FIG. 9) provided in the left front box body 76.

In the same manner, the right bottom plate 111 is welded to the other right flange portions 84, 84 of the front box body 75 and the protruding boss portion 116 (shown in FIG. 9). At the same time, the right bottom plate 111 is welded to the right flange portions 86, 86 and the protruding boss portion 118 (shown in FIG. 9) provided in the right front box body 77. In this case, the welded portion is shown by a dotted pattern.

Next, a cross-section of the beam member is shown. The front beam member 47, the left beam member 51 and the left joining portion 17 of the left beam member 51 are shown.

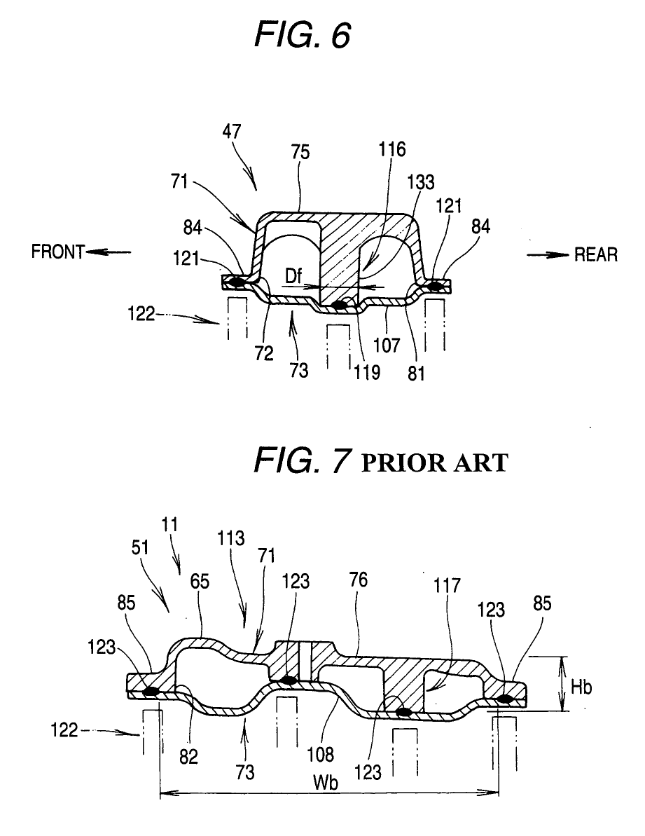

FIG. 6 is a sectional view taken on line 6-6 in FIG. 3.

The front beam member 47 is a structural pipe in which an opening 81 of the front box body 75, the transverse cross-section of which is formed into a U-shape, is closed with the front bottom plate 107.

The front box body 75 is a box member made by die casting and provided with an opening 81 and a protruding boss portion 116.

As described before, in the front beam member 47, the front bottom plate 107 of the lid member (bottom plate) is welded to the flange portions 84, 84, and the front bottom plate 107 is welded to the protruding boss portion 116. Reference numerals 119 . . . schematically show a welding portion with the boss portion 116, and reference numerals 121 . . . schematically show a welding portion with the flange portion 84.

When welding is conducted on the welded portions 119, 121, an arbitrary welding method may be used. For example, it is possible to conduct welding with FSW device 122. The flange portions 84, 84 may be welded with a welding robot (spot welding machine).

FIG. 7 is a sectional view taken on line 7-7 in FIG. 3.

The left front beam member 65 of the left beam member 51 is a structural pipe in which an opening 82 of the left front box body 76, the transverse cross-section of which is formed into a U-shape, is closed with the left bottom plate 108.

The left front box body 76 is a box member made by die casting and provided with an opening 82 and a protruding boss portion 117.

As described before, the left beam member 51 is constituted in such a manner that the left bottom plate 108 is welded to the left flange portions 85, 85 and the protruding boss portion 117 (shown in FIG. 9). Reference numerals 123 . . . schematically show a welding portion.

When welding is conducted on the welded portion 123, an arbitrary welding method may be used. For example, it is possible to conduct welding with FSW device 122. The flange portions 85, 85 may be welded with a welding robot (spot welding machine).

The right beam member 52 (shown in FIG. 3) is constituted substantially in the same manner as that of the left beam member 51.

The right front beam member 67 (shown in FIG. 3) is constituted substantially in the same manner as that of the left front beam member 65.

The flat portion 113 is a portion in which the average height H_{b} of the left front beam member 65 is reduced. A ratio of the average height H_{b} of the left front beam member 65 to the width W_{b} of the left front beam member 65 is approximately 0.15, which is a low value. The flat portion 113 is a portion formed so that it can be a start point of plastic deformation when a load, which is heavier than a normal load, is given to the sub-frame 11 in the longitudinal direction (the direction of arrow a1 in FIG. 1).

The flat portion 114 (shown in FIGS. 3 and 4) is constituted substantially in the same manner as that of flat portion 113. Therefore, the explanations of the flat portion 114 are omitted here.

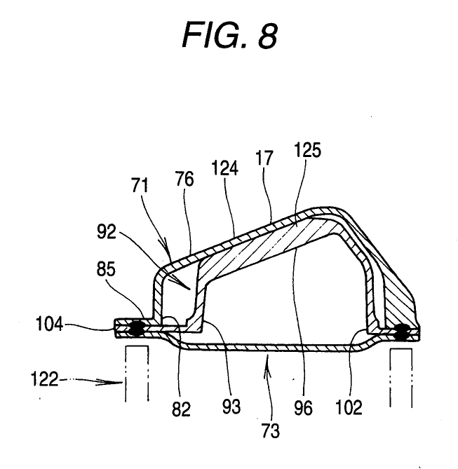

FIG. 8 is a sectional view taken on line 8-8 in FIG. 3.

The left joining portion 17 includes: a beveling portion 124 formed in the left front box body 76 of the front box member 71; a beveling portion 125 formed in the left rear box body 96 of the rear box member 92; and a welded portion 126 (shown in FIG. 3) formed by fillet welding in which the beveling portion 124 is put on the beveling portion 125 and then fillet welding is conducted on the beveling portions 124, 125.

The right joining portion 18 (shown in FIG. 3) is constituted substantially in the same manner as that of the left joining portion 17.

FIG. 9 is a lower view of a front box member provided in the sub-frame of a vehicle of the present invention.

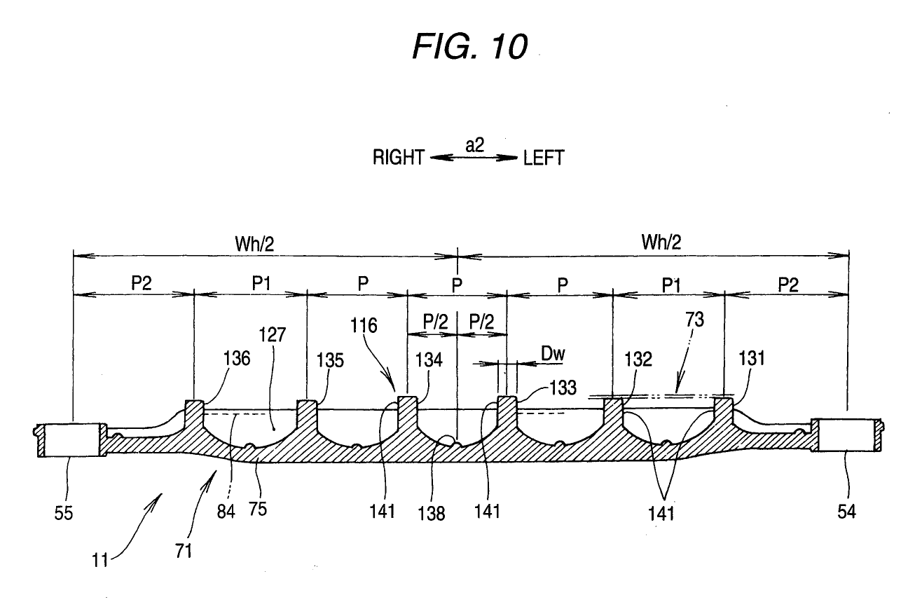

FIG. 10 is a sectional view taken on line 10-10 in FIG. 9. Explanations will be made referring to FIGS. 9 and 10 together with FIG. 5.

The front box member 71 made by die casing includes a front box body 75. The front box body (box member) 75 includes a plurality of protruding boss portions 116 which are arranged on the inner face 127 in the longitudinal direction (the direction of arrow a2) of the front box body 75. In this case, the plurality of protruding boss portions 116 are a first to a sixth boss portion 131 to 136.

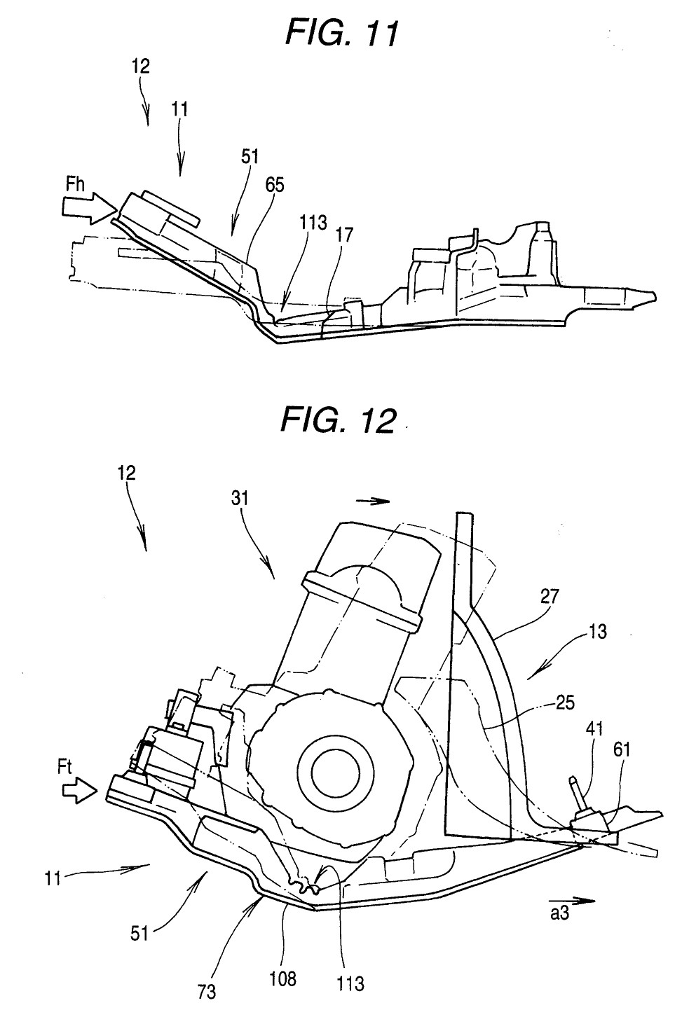

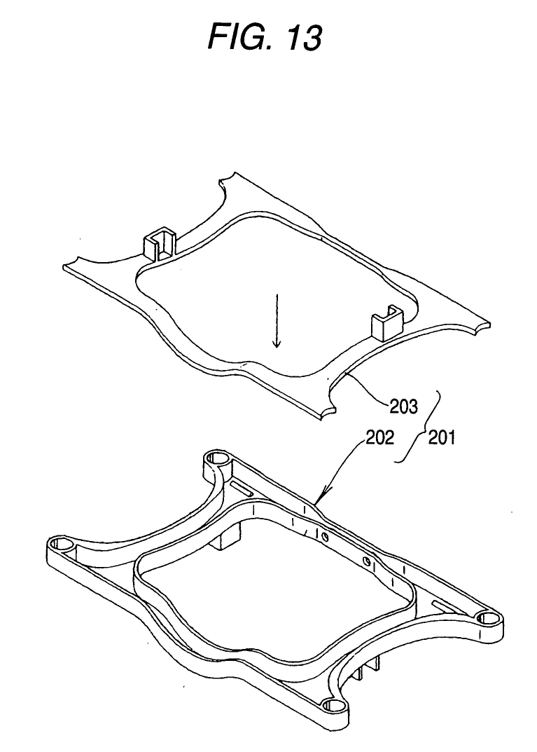

The protruding boss portion 116 is a support pillar, at the forward end portion of which a front bottom plate 107, a left bottom plate 108 and a right bottom plate 111 of the lid member (bottom plate) 73 are attached. The protruding boss portion 116 is also used as a pushing seat for releasing a molding from a die casting mold 137 (shown in FIG. 11).

Specifically, the third and the fourth pushing boss portion 133, 134, which are located at the center, are formed from the central portion 138 in the longitudinal direction of the front box body 75 at pitch P/2, the second and the fifth pushing boss portion 132, 135 are formed at pitch P, and the first and the sixth protruding boss portion 131, 136 are formed at pitch P1 being distant by distance P2 from the front attaching portions 54, 55 of both end portions. A pitch between the third protruding boss portion 133 and the fourth protruding boss portion 134 is P.

More specifically, a horizontal cross-section of the protruding boss portion 116 is a substantial ellipse. A major axis of the ellipse is D_{w}, and a minor axis of the ellipse is D_{f}.

Next, operation of the sub-frame 11 of a vehicle of the present invention will be explained below.

FIG. 11 is a first view showing an action of the sub-frame of the present invention. Explanations will be made referring to FIG. 11 and together with FIGS. 1 and 3.

When a force stronger than a normal force is given to the front of the vehicle 12, the force Fₕ is transmitted to the left beam member 51 of the sub-frame 11. When the force Fₕ is given to the left beam member 51, plastic deformation starts from the flat portion 113 formed in the left front beam member 65. At the same time, the flat portion 113 is plastically deformed. Therefore, when the mechanical strength of the left joining portion 17 is made to be equal to that of the shape on the mother material side or the mechanical strength of the left joining portion 17 is made to be higher than that of the shape on the mother material side, there is no possibility of the generation of plastic deformation from the left joining portion 17. As a result, it is possible to enhance a degree of freedom of the beveling shape of the left joining portion 17.

When the force Fₘ, which is substantially equal to the force Fₕ, is given to the right beam member 52, plastic deformation starts from the flat portion 114 formed in the right front beam member 67. At the same time, the flat portion 114 is plastically deformed. Therefore, when the mechanical strength of the right joining portion 18 is made to be equal to that of the shape on the mother material side or the mechanical strength of the right joining portion 18 is made to be higher than that of the shape on the mother material side, there is no possibility of the generation of plastic deformation from the right joining portion 18. As a result, it is possible to enhance a degree of freedom of the beveling shape of the right joining portion 18.

As described above, a sub-frame 11 of a vehicle, which is made by means of die casting into a substantially rectangular and attached to a front lower portion 14 of a vehicle body 13, including: a C-shaped front sub-frame 15; and a C-shaped rear sub-frame 16, wherein a right and a left front beam members 67, 65, which are formed at a right and a left end portion of a front beam member 47 constituting the front sub-frame 15, and a right and a left rear beam members 91, 88, which are formed at a right and a left end portion of a rear beam member 53 constituting the rear sub-frame 16, are joined to each other, and flat portions 114, 113 are formed in the right and the left front beam members 67, 65 so that the flat portions 114, 113 can be start points of plastic deformation of the sub-frame 11 when a load, which is heavier than a normal load, is given to the sub-frame 11 in the longitudinal direction. Therefore, when the mechanical strength of the right and the left joining portions 18, 17 is made to be equal to that of the shape on the mother material side of the right and the left beam member 52, 51 or the mechanical strength of the right and the left joining portions 18, 17 is made to be higher than that of the shape on the mother material side, there is no possibility of the generation of plastic deformation from the joining portions. As a result, it is possible to enhance a degree of freedom of the shapes of the right and left joining portions 18, 17.

When the degree of freedom of the right and left joining portions 18, 17 is enhanced, it is possible to enhance a degree of freedom of welding. Therefore, the working time for joining can be reduced.

FIG. 12 is a second view showing an action of the sub-frame of the present invention. Explanations will be made referring to FIG. 12 together with FIGS. 1 and 3.

When a force stronger than a normal force is given to the front of the vehicle 12, the force Fₜ is transmitted to the left beam member 51 of the sub-frame 11. Then, while the left beam member 51 is being bent without being broken, it transmits the load to the rear attaching portion 61 provided at the rear portion of the sub-frame 11. At this time, since a left bottom plate 108, which is an expanded material, is joined to the flat portion 113, the left bottom plate 108 is not broken but bent, and the load can be positively transmitted to the rear attaching portion 61 of the rear portion being positively controlled. As a result, the rear attaching portion 61 comes out from the floor member 25 of the vehicle body 13 and slides backward as shown by the arrow a3. Accordingly, a region for absorbing a shock can be expanded, that is, it is possible to ensure a crashable stroke.

On the other hand, the right beam member 52 can conduct the same action and exhibit the same advantages.

As described above, in the sub-frame 11 of a vehicle, cross-sections of the right and the left front beam members 67, 65 and the right and the left rear beam members 68, 66 are respectively formed into a hollow cross-section, one side of which is open, that is, the right and the left opening 83, 82 are open. At least, in the flat portions 113, 114, the expanded material plates (the right and the left bottom plate) 111, 108 are joined so that the right opening 83 and the left opening 82 can be closed. Therefore, the flat portion 114, 113 are not broken but bent by the expanded material plates (the right and the left bottom plate) 111, 108, and a load transmitted to the rear attaching portions 61, 62 provided at the rear can be positively controlled. As a result, the rear attaching portions 61, 62 come out from the floor members 25, 25 of the vehicle body 13 and slide backward as shown by the arrow a3. Accordingly, it is possible to ensure a crashable stroke.

In this connection, no problems are caused when the sub-frame of a vehicle of the present invention is applied to a vehicle for common use.

The sub-frame of a vehicle of the present invention is preferably applied to a four-wheel car.

What is claimed is:

1. A sub-frame of a vehicle, which is made by means of die casting into a substantially rectangular shape and attached to a front lower portion of a vehicle body, comprising:
a C-shaped front sub-frame including a front beam member, a right front beam member extending from one end portion of the front beam member backward the vehicle body and a left front beam member extending from other end portion of the front beam member backward the vehicle body; and
a C-shaped rear sub-frame including a rear beam member, a right rear beam member extending from one end portion of the rear beam member frontward the vehicle body and a left rear beam member extending from other end portion of the rear beam member frontward the vehicle body, wherein
the right front beam member and the right rear beam member are jointed to each other,
the left front beam member and the left rear beam member are jointed to each other, and
vulnerable portions are formed in the right and the left beam member and are placed apart from jointed portions.

2. The sub-frame of a vehicle according to claim 1, wherein
cross-sections of the right and the left front beam members, and the right and the left rear members are respectively formed into a hollow cross-section, one side of which is open, and
a part of open portions of the cross-sections that include the vulnerable portions are covered by expanded material plate.

3. The sub-frame of a vehicle according to claim 1, wherein
the vulnerable portions form flat portions which are thinner than other portions.

4. The sub-frame of a vehicle according to claim 1, wherein
the joint portions are slant with respect to the direction along which the right and the left beams extend.

5. The sub-frame of a vehicle according to claim 2, wherein
the expanded material plates are jointed by friction stir welding.

6. A sub-frame forming method for forming a sub-frame of a vehicle, which is made by means of die casting into a substantially rectangular shape and attached to a front lower portion of a vehicle body, the method comprising the steps:
forming a C-shaped front sub-frame including a front beam member, a right front beam member extending from one end portion of the front beam member backward the vehicle body and a left front beam member extending from other end portion of the front beam member backward the vehicle body; and
forming a C-shaped rear sub-frame including a rear beam member, a right rear beam member extending from one end portion of the rear beam member frontward the vehicle body and a left rear beam member extending from other end portion of the rear beam member frontward the vehicle body,
joining the right front beam member and the right rear beam member, and
joining the left front beam member and the left rear beam member, wherein
vulnerable portions are formed in the right and the left beam member and are placed apart from jointed portions.

7. The sub-frame forming method according to claim 6, wherein
cross-sections of the right and the left front beam members, and the right and the left rear members are respectively formed into a hollow cross-section, one side of which is open, and
a part of open portions of the cross-sections that include the vulnerable portions are covered by expanded material plate.

8. The sub-frame forming method according to claim 6, wherein
the vulnerable portions form flat portions which are thinner than other portions.

9. The sub-frame forming method according to claim 6, wherein
the joint portions are slant with respect to the direction along which the right and the left beams extend.

10. The sub-frame forming method according to claim 7, wherein
the expanded material plates are jointed by friction stir welding.
